(19) United States
(12) Patent Application Publication
(10) Pub. No.: US 2025/0178369 A1
(43) Pub. Date: Jun. 5, 2025

(54) Media Processing Device Having a Ribbon Positioning Feature in Lid

(71) Applicant: ZEBRA TECHNOLOGIES CORPORATION, Lincolnshire, IL (US)

(72) Inventors: Zhong Gui Wang, Guangzhou (CN); Yong Liu, Guangzhou (CN); QiMing Feng, Guangzhou (CN); Huanhua Liao, Guanghzou (CN)

(21) Appl. No.: 18/844,380

(22) PCT Filed: Mar. 7, 2022
(86) PCT No.: PCT/CN2022/079591

§ 371 Date: Sep. 5, 2024

(51) Int. Cl. B41J 35/00; B41J 29/13; B41J 32/00

(52) U.S. Cl. CPC B41J 35/00; B41J 29/13; B41J 32/00

(57) ABSTRACT

An example disclosed printer includes a base. The printer further includes a lid attached to the base movable between a closed position in which the lid is secured to the base, and an open position in which the lid is at least partially separated from the base. The printer further includes an arcuate slot disposed on an inside surface of the lid. The printer further includes a ribbon frame disposed within the printer, and a ribbon frame post secured to the ribbon frame and disposed within the arcuate slot. When the lid is moved to the open position, the arcuate slot lifts the ribbon frame post and causes the ribbon frame to move to a presenting position.

### BACKGROUND OF THE INVENTION

From time to time, printers exhaust the available supply of media such that a user must replace the media supply spool. Other consumables such as ribbon or ribbon cartridges and the like must also be periodically replaced. Replacing consumable components of a printer can often be complex and arduous, with the time to replace such components resulting in costly downtime of the media processing device. Spooled media has a tendency to unwind when not locked in the printer, which can cause tension or slack issues within the printer. Therefore, there is a need for improved devices and system which addresses this problem by providing more robust configurations that utilize less parts than some prior designs. Through applied effort, ingenuity, and innovation.

### SUMMARY

The following invention comprises a printer having a base assembly. The printer further has a lid assembly attached to the base assembly, the lid assembly movable between a closed position in which the lid assembly is secured to the base assembly, and an open position in which the lid assembly is at least partially separated from the base assembly, wherein the lid assembly further comprises a window assembly. The printer further has an arcuate slot disposed on an inside surface of the window assembly, and a ribbon frame disposed within the printer. The printer further has a ribbon frame post secured to the ribbon frame and disposed within the arcuate slot, wherein when the lid assembly is moved to the open position, the arcuate slot lifts the ribbon frame post and causes the ribbon frame to move to a presenting position.

### BRIEF DESCRIPTION OF THE SEVERAL VIEWS OF THE DRAWING(S)

Reference will now be made to the accompanying drawings, which are not necessarily drawn to scale, and wherein:

FIG. 1 illustrates a housing view of a printer according to example embodiments of the present invention;

FIG. 2 illustrates a detail view of an open printer showing a ribbon frame according to an example embodiment of the present invention;

FIG. 3 illustrates a close-up view of an arcuate slot on a window assembly within a lid assembly according to an example embodiment of the present invention;

FIGS. 4A-4D illustrate a printer moving from a closed position to an open position according to an example embodiment of the present invention; and

FIG. 5 illustrates an orthogonal via of a window assembly according to an example embodiment of the present invention.

### DETAILED DESCRIPTION OF THE INVENTION

Various embodiments of the present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

Printers and media processing devices may be configured to print and/or encode media drawn from a roll or spool. Such media may include a web supporting a plurality of individually cut media components, such as adhesive-backed and carrier-supported labels, or the media may be a continuous web such as a spool of liner-less label media. Printers process (e.g., print, encode, etc.) the media by drawing the media from the spool and routing the media proximate various processing components (e.g., printhead, RFID reader/encoder, magnetic stripe reader/encoder etc.). Processing the media from a spool may facilitate a continuous or batch printing process.

Replacement of consumable components can be even more difficult for media processing devices of relatively small form factors, such as desktop or mobile printers, as the components are generally tightly packaged into a relatively small housing. As such, it may be desirable for a media processing device to provide easy access to the consumable components therein to facilitate relatively quick and easy replacement of consumable components, particularly for a printer including a small form factor. With printers having a small form factor, requiring a media supply spool and a ribbon cartridge simultaneously, a ribbon frame may be used in the printer.

The ribbon frame fits within the printer when the printer is closed and raises to a presenting position when the printer is opened fully, which allows a ribbon cartridge to be removed or installed. Past ribbon frames have moved in relation with the printer's lid due to a complicated system of linkages and parts. It is important to note, that the ribbon frame cannot be directly, rigidly secured to the lid and raised and lowered with the lid. If this was to happen then the ribbon frame would not be accessible in the open position for the loading of a ribbon cartridge. Therefore, it is important that the ribbon frame is presented to the user when in the open position.

Embodiments of the present invention are directed to a printer comprising a base assembly, a lid assembly attached to the base assembly movable between a closed position in which the lid assembly is secured to the base assembly, and an open position in which the lid assembly is at least partially separated from the base, an arcuate slot disposed on an inside surface of the lid, a ribbon frame disposed within the printer, and a ribbon frame post secured to the ribbon frame and disposed within the arcuate slot, wherein when the lid assembly is moved to the open position, the arcuate slot lifts the ribbon frame post and causes the ribbon frame to move to a presenting position.

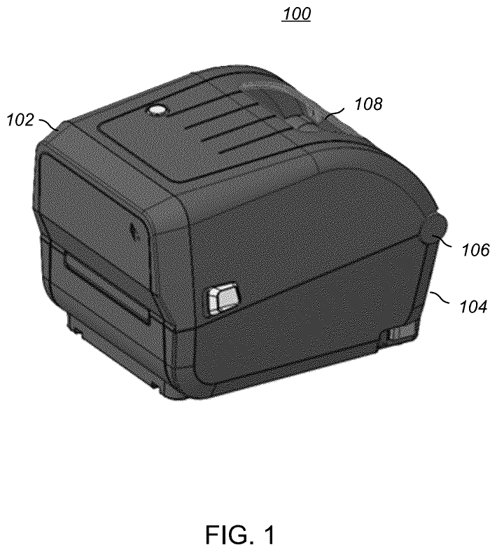

FIG. 1 illustrates a printer or processing device according to example embodiments of the present invention. The illustrated embodiment depicts an outer view of a media processing device 100 (also referred to herein as ‘printer’). While the illustrated embodiments and description provided herein are directed primarily to a printing device, other media processing devices such as media encoders, label applicators, or laminators, may benefit from the mechanisms described.

The printer 100 of FIG. 1 includes a housing with a base assembly 104 and a lid assembly 102. According to the illustrated embodiment, the lid assembly 102 and the base assembly 104 are arranged in a closed position in which the lid assembly 102 is secured to the base assembly 104. The lid assembly 102 may be pivotably attached to the base assembly 104 along a hinge 106, which may be located, for example, along a back side of the printer. In the illustrated embodiment, the lid assembly 102 is configured, when opened, to pivot along the hinge 106 to an open position. In the illustrated embodiment, the lid assembly 102 comprises a window 108. The window 108 may be part of a window assembly which will be discussed below.

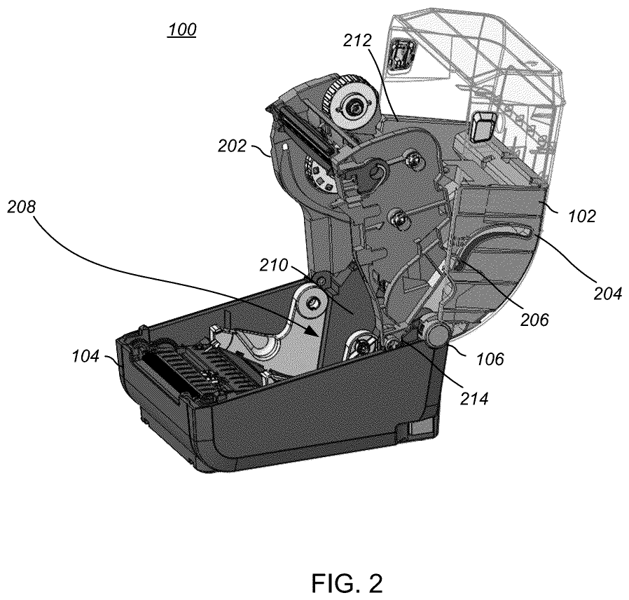

FIG. 2 illustrates the printer 100 of FIG. 1 in the open position. In the depicted embodiment, when printer 100 is in the open position, the lid assembly 102 is pivoted away from the base assembly 104 to the open position. When the printer 100 is in the open position, a ribbon frame 202 can be seen. The frame 202 presents a ribbon cartridge (unseen) from within the printer 100 for removal or to allow for accessible installation of the ribbon cartridge. The ribbon frame 202 also aligns the ribbon cartridge within the printer 100 so that the printhead of the printer 100 can reliably interact with the ribbon cartridge and the ribbon.

The base assembly 104 may further include a lower frame 212 located within the base assembly 104. The lower frame 212 provides rigidity within the base assembly 104 and purchase locations for other elements of the printer to connect to the base assembly 104. For example, the hinge 106 may be connected to the base assembly 104 via the lower frame 212. The lower frame 212 may also be attached to media holders, a platen, or other elements common to a printer 100.

In the illustrated embodiment, the lid assembly 102 is pivotably attached to the lower frame 212 at hinge 106. When the lid assembly 102 is in the closed position, the lid assembly 102 latches to the base assembly 104 and the lid assembly 102 requires actuation to unlatch and open.

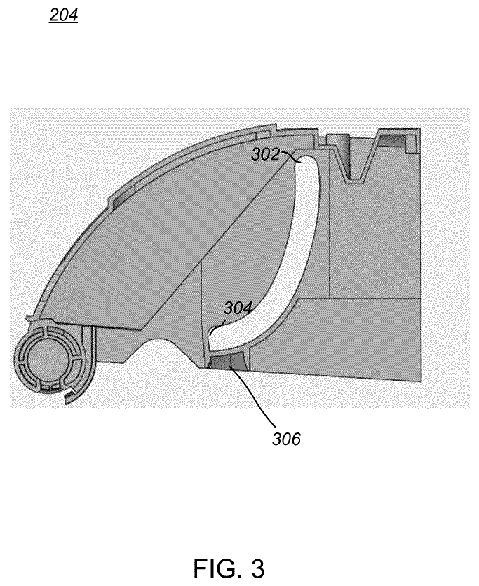

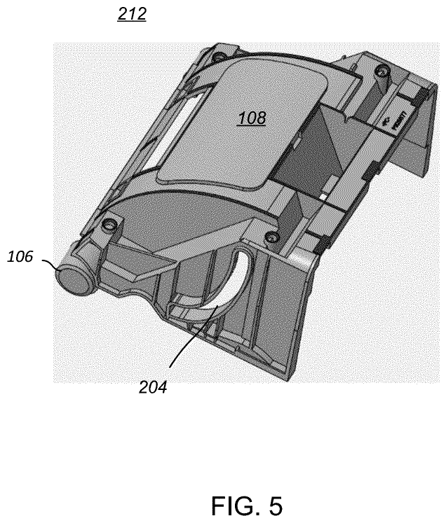

In the illustrated embodiment of FIG. 2, the lid assembly 102 comprises a window assembly 212 supporting an arcuate slot 204 on an inner surface of the window assembly 212. The arcuate slot 204 can be seen in closer detail in FIG. 3. The window assembly 212 is shown in further detail in FIG. 5. In the depicted embodiment, the arcuate slot 204 is integral with the window assembly 212, the arcuate slot 204 being molded with the window assembly 212 during manufacturing. The window assembly 212 may act to provide additional support and rigidity to the lid assembly 102. The additional support provided by the window assembly 212 may be desirable when the arcuate slot 204 interacts with the ribbon frame post 206. The window assembly 212 may connect with the hinge 106. The window assembly 212 of FIG. 5 has window element 108 which can be seen in FIG. 1 of the exterior of the printer 100. Interactions between the arcuate slot 204 other elements of the printer will be discussed further below. The arcuate slot 204 may be more or less curved as needed to generate the desired results, which will be described further below.

As can be seen in FIG. 2, when the lid assembly 102 (shown in FIG. 2 as transparent) and the ribbon frame 202 are both in the open position, a cavity 208 within the printer can be accessed. The cavity 208 receives media to be processed by the printer 100. The media within the cavity can then be fed through the front of the printer so that when the lid assembly 102 is closed, the printer 100 is able to process the media.

In the illustrated embodiment in FIG. 2, the ribbon frame 202 is configured to raise in response to the lifting of lid 102. In comparison, when the lid 102 is in the closed position, and the ribbon frame 202 is then configured to fit within the closed printer 100. The ribbon frame 202 is configured to rotate around a pivot point 214 when moving between the open and closed position. As can be seen in FIG. 2, the pivot point 214 is mounted to the lower frame 210, however it should be known that the pivot point 214 can also be integral to the hinge 106 or mounted to the lid assembly 102.

As can be seen in FIG. 2, the ribbon frame 202 may be configured to receive a ribbon cartridge or ribbon spools (not seen) in between. In the illustrated embodiment in FIG. 2, ribbon frame 210 supports a ribbon frame post 206. The ribbon frame post 206 comprises a protrusion from at least one side of the ribbon frame 202. As illustrated in FIG. 2, the ribbon frame post 206 protrudes from a rear area of the ribbon frame 202.

The ribbon assembly post 206 is configured to fit within an arcuate slot 204. As illustrated in FIG. 2, the arcuate slot 204 is situated on the inside of the lid assembly 102. The arcuate slot 204 is wide enough to allow the ribbon frame post 206 to pass from the first end to the second end of the arcuate slot 204, as will be further described below. The arcuate slot 204 is shaped such that when the lid assembly 102 is moved from the closed position to the open position, the ribbon frame post 206 moves from the first end 302 of the arcuate slot 204 to the second end 304 of the arcuate slot 204. The shape and position of the arcuate slot 204 on the lid assembly 102 is directly related to the speed at which the ribbon frame 202 moves during opening or closing of the lid assembly 102.

According to some embodiments, a cavity 208 may be defined between the lid assembly 102 and the base assembly 104. The cavity may be inaccessible when the lid assembly 102 is closed relative to the base assembly 104 as shown in FIG. 2; however, the cavity 208 may be accessible to a user when the lid assembly 102 is moved to an open position relative to the base assembly 104 as will be described further below.

FIG. 3 illustrates a close-up view of the arcuate slot 204. In the illustrated embodiment, the arcuate slot 204 is formed by a groove inset in an inner wall of the lid assembly 102. In other embodiments, the arcuate slot 204 may be formed by an extended wall tracing around a perimeter of the arcuate slot 204. As mentioned above and illustrated in FIG. 3, the arcuate slot 204 has a first end 302 and a second end 304. In the depicted embodiment, the ribbon frame post 206 is located at the second end 304 of the arcuate slot 204 when the lid assembly 102 is in the open position.

FIG. 3 illustrates an entry point 306 near the second end 304 of the arcuate slot 204. The entry point 306 is a barrier located at the second end of the arcuate slot 204 which prevents the ribbon frame post from exiting the arcuate slot 204 and allows the ribbon frame post to enter the arcuate slot 204.

In the illustrated embodiment, when the lid assembly 102 is in the open position, the lid assembly 102 is supporting the ribbon frame 202 via the arcuate slot in the window assembly. When in the open position, the ribbon frame post 206 is adjacent to the entry point 306 and prevented from leaving the arcuate slot 204. At the same time, the ribbon frame 202 also cannot lower because the ribbon frame post 206 is being retained within the arcuate slot 204.

In the illustrated embodiment, the entry point 306 comprises a chamfer 308 on a side of the entry point 306 outside the arcuate slot 204. The chamfer 308 allows a user to easily load the ribbon frame post 206 into the arcuate slot 204. When the ribbon frame post 206 is forced against the chamfer 308 side of the entry point 306, the slanted surface of the chamfer 308 requires less force for the ribbon frame post 206 to slide past. The window assembly may be configured to deform slightly outwards in response to the ribbon frame post 206 sliding past the entry point 306. Once the ribbon frame post 206 is within the boundaries of the arcuate slot 204, the window assembly reforms to the standard shape of the lid 102.

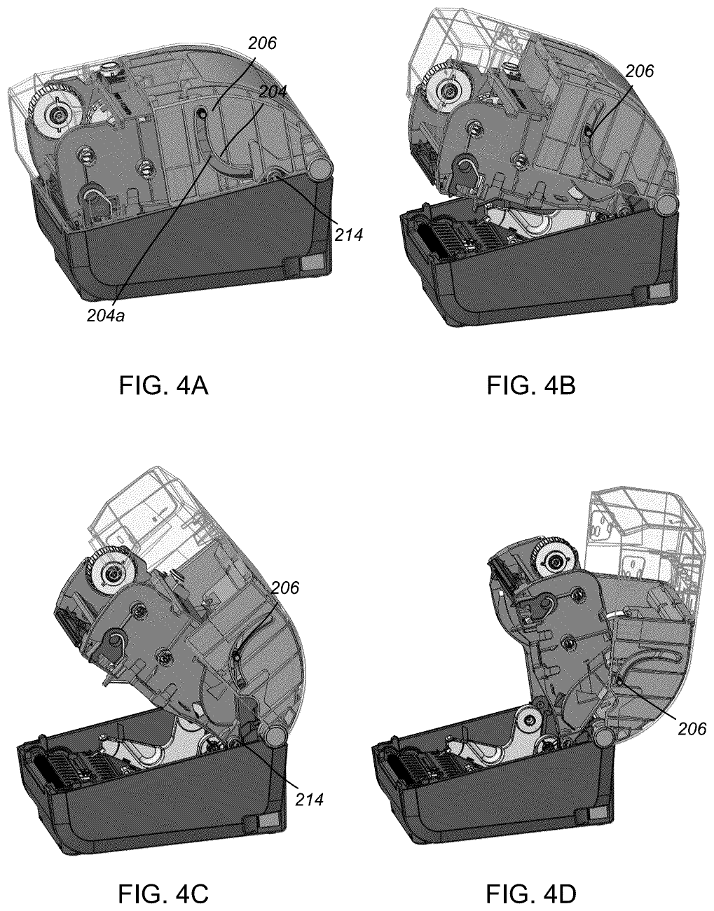

FIG. 4A-4D illustrates the relationship between the base 104, the lid 102, and the ribbon frame 202 as the printer 100 transitions from a closed position in FIG. 4A to an open position in FIG. 4D.

As illustrated in FIGS. 4A-4D, as a user lifts the lid assembly 102, the arcuate slot 204 interacts with the ribbon frame post 206. In the depicted embodiment, the arcuate slot 204 is integral with the window assembly which is attached to the lid assembly 102 and therefore moves with the lid during opening. When the ribbon frame post 206 is within the arcuate slot 204, the ribbon frame post 206 interacts with the sides of the arcuate slot 204 during the raising or lowering of lid assembly 102. As the arcuate slot 204 raises, the ribbon frame post 206 contacts a front wall 204a of the arcuate slot 204 which causes the ribbon frame post 206 to raise with the arcuate slot 204.

In illustrated FIGS. 4A-4D, the ribbon frame post 206 is integral with the ribbon frame 202, which causes the ribbon frame 202 to be moved with the lifting of the lid assembly 102 via the interaction of the ribbon frame post 206 with the arcuate slot 204. The movement of the ribbon position assembly 202 is from the closed position depicted in FIG. 4A to a presenting position in FIG. 4D. As mentioned above, when the ribbon frame 202 is in the presenting position, ribbon can be loaded or unloaded.

As illustrated in FIGS. 4A-4D, the ribbon frame post 206 contacts the front wall 204a of the arcuate slot 204. In the illustrated embodiment, the curvature of front wall 204a matches the curvature of the arcuate slot 204. As the front wall 204a contacts the ribbon frame post 206 and lifts the ribbon frame post 206 from the position seen in FIG. 4A to the position in FIG. 4D. As the ribbon frame post 206 translates against the front wall 204a, the curvature of the front wall 204a directly relates to the relationship between the ribbon frame 202 and the lid 102 as well as the rate of which the ribbon frame 202 is raised.

As can be seen in the progression from FIG. 4A-4D, the ribbon frame post 206 slides within the arcuate slot 204 from the first end 302 of the arcuate slot 204 to the second end 304 of the arcuate slot 204. It should be noted that the curvature of the arcuate slot 204 has a direct related to the rate of which the ribbon frame 202 is raised.

With regards to the curvature of the arcuate slot 204, if the radius of the arcuate slot 204 is smaller, the ribbon frame 202 will close faster than the lid 102. Conversely, if the radius of the arcuate slot 204 is greater, then the ribbon frame 202 will close slower than the lid assembly 102. This is because the ribbon frame post 206 follows the path of the arcuate curve 204 and the movement of the ribbon frame post 206 is related to the position and shape of the arcuate slot 204.

In the illustrated embodiment, once the ribbon frame 102 reaches an 80 degree opening, a friction fit within the pivot point 214 will cause the ribbon frame 202 to stay in the presenting position. The ribbon frame 202 may then stay in the open position until the lid assembly 102 is closed and the process reverses. When the lid assembly 102 moves to the closed position, the embodiments move from FIG. 4D to FIG. 4A. As the lid assembly 102 is lowered, the arcuate slot 204 contacts the ribbon frame post 206 and applies enough force to overcome the friction fit within the pivot point 214 which causes the ribbon frame to begin to lower with the lid 102.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . aa”, “has . . . aa”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

That which is claimed:

1. A printer comprising:
a base assembly;
a lid assembly attached to the base assembly, the lid assembly movable between a closed position in which the lid assembly is secured to the base assembly, and an open position in which the lid assembly is at least partially separated from the base assembly, wherein the lid assembly further comprises a window assembly;
an arcuate slot disposed on an inside surface of the window assembly;
a ribbon frame disposed within the printer; and
a ribbon frame post secured to the ribbon frame and disposed within the arcuate slot;
wherein when the lid assembly is moved to the open position, the arcuate slot lifts the ribbon frame post and causes the ribbon frame to move to a presenting position.

2. The printer of claim 1, wherein the arcuate slot has a first arcuate slot end and a second arcuate slot end such that the ribbon frame post is configured to translate within the arcuate slot from the first slot end to the second slot end.

3. The printer of claim 2, wherein when the lid assembly is raised to the open position, the ribbon frame post moves from the first arcuate slot end to the second arcuate slot end, wherein the ribbon frame post causes the ribbon frame to pivot into the open position.

4. The printer of claim 1, further comprising a cavity defined between the lid assembly and the base assembly, wherein the cavity is inaccessible when the lid assembly is in the closed position and the cavity is accessible when the lid assembly is in the open position.

5. The printer of claim 1, wherein the ribbon frame post is integral to the ribbon frame.

6. The printer of claim 1, wherein the ribbon frame post moves from a first end of the arcuate slot when the lid assembly is in the closed position to a second end of the arcuate slot when the lid assembly is in the open position.

7. The printer of claim 1, wherein the arcuate slot is configured to allow the ribbon frame post to move within the arcuate slot from a first end of the arcuate slot to a second end of the arcuate slot, and the arcuate slot having a rest point along the arcuate slot between the first end of the arcuate slot and the second end of the arcuate slot wherein the ribbon frame post is configured to be stationary at the rest point relative to the arcuate slot.

8. The printer of claim 7, wherein when the ribbon frame post is stationary at the rest point, the lid assembly and the ribbon frame are also stationary.

9. The printer of claim 1, wherein the ribbon frame is pivotably attached to at least one of the lid assembly or the base assembly and is configured to move between a closed position when the lid assembly is in the closed position and a presenting position when the lid assembly is in the open position.

10. The printer of claim 9, wherein when the lid assembly is moved to the open position, the arcuate slot raises with the lid assembly causing the ribbon frame post to contact a side of the arcuate slot and move in conjunction with the arcuate slot.

11. A printer comprising:
a ribbon frame disposed within the printer, the ribbon frame configured to position media within the printer;
a ribbon frame post attached to the ribbon frame;
a lid; and
an arcuate slot on an inner surface of the lid;
wherein:
the ribbon frame post is disposed within the arcuate slot; and when the lid is raised the ribbon frame is configured to raise concurrently with the lid via the interaction between the ribbon frame post and the arcuate slot.

12. The printer of claim 11, wherein the arcuate slot has a first arcuate slot end and a second arcuate slot end such that the ribbon frame post is configured to translate within the arcuate slot from the first slot end to the second slot end.

13. The printer of claim 12, wherein when the lid is raised to the open position, the ribbon frame post moves from the first arcuate slot end to the second arcuate slot end, wherein the ribbon frame post causes the ribbon frame to pivot into the open position.

14. The printer of claim 11, further comprising a cavity defined between the lid and a base, wherein the cavity is inaccessible when the lid is in the closed position and the cavity is accessible when the lid is in the open position.

15. The printer of claim 11, wherein the ribbon frame post is integral to the ribbon frame.

16. The printer of claim 11, wherein the ribbon frame post moves from a first end of the arcuate slot when the lid is in the closed position to a second end of the arcuate slot when the lid is in the open position.

17. The printer of claim 11, wherein the arcuate slot is configured to allow the ribbon frame post to move within the arcuate slot from a first end of the arcuate slot to a second end of the arcuate slot, and the arcuate slot having a rest point along the arcuate slot between the first end of the arcuate slot and the second end of the arcuate slot wherein the ribbon frame post is configured to be stationary at the rest point relative to the arcuate slot.
